(19) United States
(12) Patent Application Publication
(10) Pub. No.: US 2015/0348354 A1
(43) Pub. Date: Dec. 3, 2015

(54) GAME MACHINE, CONTROL METHOD OF CONTROLLING COMPUTER USED IN GAME MACHINE, AND COMPUTER PROGRAM

(71) Applicants: Masato OKUAKI, Zama-shi (JP); Toru OMOTO, Zama-shi (JP); Daisuke MATSUKI, Zama-shi (JP); Tomoaki HIRAI, Zama-shi (JP)

(72) Inventors: Masato OKUAKI, Zama-shi (JP); Toru OMOTO, Zama-shi (JP); Daisuke MATSUKI, Zama-shi (JP); Tomoaki HIRAI, Zama-shi (JP)

(73) Assignee: Konami Gaming, Inc., Las Vegas, NV (US)

(21) Appl. No.: 14/423,682

(22) PCT Filed: Aug. 31, 2012
(86) PCT No.: PCT/US2012/053491

§ 371 Date: Jul. 29, 2015

(51) Int. Cl. G07F 17/32

(52) U.S. Cl. CPC G07F 17/329; G07F 17/3211

(57) ABSTRACT

A game machine comprising a roulette game unit in which a lottery is executed by a roulette game, wherein a deceleration interval which is an interval to decelerate a roulette ring in the roulette game is changed so that lottery time which is time taken for one lottery of the roulette game unit falls within a predetermined target range. Further, the deceleration interval is changed based on the lottery time of past lottery executed by the roulette game unit.

### TECHNICAL FIELD

The present invention relates to a game machine having a physical lottery mechanism which executes a lottery by a roulette game.

### BACKGROUND ART

There is known a game machine having a roulette type physical lottery mechanism which in practice rotates a roulette wheel and feeds a ball onto the wheel to execute a lottery (for example, see Patent Literature 1).
Patent Literature 1: JP-A-2009-112776.

### SUMMARY OF INVENTION

### Technical Problem

In the roulette type physical lottery mechanism as shown in the Patent Literature 1, a time taken for one lottery (lottery time) is determined by the movement of the wheel or the ball. Thereby, there is a possibility of increasing variation in lottery time.

In view of the foregoing, an object of the present invention is to provide a game machine which can decrease the variation in lottery time, a control method of controlling a computer used in the game machine, and a computer program.

### Solution to Problem

In order to solve the above problems, a game machine according to the present invention comprises a physical lottery mechanism in which a lottery is executed by a roulette game, wherein the game machine comprises a parameter changing device configured to change a parameter value which affects lottery time, which is time taken for one lottery of the physical lottery mechanism, of the lottery to be executed by the physical lottery mechanism based on the lottery time of at least one past lottery executed by the physical lottery mechanism, so that the lottery time falls within a predetermined target range.

According to the present invention, since the parameter value is changed so that the lottery time falls within a target range, it is possible to decrease the variation of drawing time. Further, the parameter value is changed based on the past lottery time. In other words, the parameter value is changed by feedback of the past lottery time. Accordingly, the parameter can be changed appropriately.

Also, in order to solve the above problem, a control method of controlling a computer according to the present invention is a control method of controlling a computer which is incorporated in a game machine comprising a physical lottery mechanism in which a lottery is executed by a roulette game, wherein the control method of controlling the computer comprises a parameter changing step configured to change a parameter value which affects lottery time, which is time taken for one lottery of the physical lottery mechanism, of the lottery to be executed by the physical lottery mechanism based on the lottery time of at least one past lottery executed by the physical lottery mechanism, so that the lottery time falls within a predetermined target range.

Also, in order to solve the above problems, a computer program for a game machine according to the present invention is a computer program for a game machine being configured to cause a computer, which is incorporated into a game machine comprising a physical lottery mechanism in which a lottery is executed by a roulette game, to function as a parameter changing device configured to change a parameter value which affects lottery time, which is time taken for one lottery of the physical lottery mechanism, of the lottery to be executed by the physical lottery mechanism based on the lottery time of at least one past lottery executed by the physical lottery mechanism, so that the lottery time falls within a predetermined target range. It is possible to provide a game system of the present invention by executing the control method or the computer program of the present invention.

### BRIEF DESCRIPTION OF DRAWINGS

FIG. 1 is an external appearance view of a game machine according to a first embodiment of the present invention.

FIG. 2 is a functional block diagram describing a schematic configuration of a control system of the game machine according to the first embodiment.

FIG. 3 is a graph showing temporal variations of a duty ratio of a ring drive mechanism.

FIG. 4 is a flowchart showing a roulette control routine in the first embodiment.

FIG. 5 is a flowchart showing a parameter setting routine in the first embodiment.

FIG. 6 is an enlarged view showing a part of a center unit of a game machine according to a second embodiment of the present invention.

FIG. 7 is an enlarged perspective view showing a center slope.

FIG. 8 is a view showing the center slope viewed in a direction of an arrow VIII in FIG. 7.

FIG. 9 is a view showing the center slope viewed in a direction of an arrow IX in FIG. 8.

FIG. 10 is a functional block diagram describing a schematic configuration of a control system of the game machine according to the second embodiment.

FIG. 11 is a flowchart showing a parameter setting routine in the second embodiment.

FIG. 12 is an enlarged view showing a center slope of a game machine according to a third embodiment of the present invention.

FIG. 13 is a functional block diagram describing a schematic configuration of a control system of the game machine according to the third embodiment.

FIG. 14 is a flowchart showing a roulette control routine in the third embodiment.

FIG. 15 is a flowchart following FIG. 14.

FIG. 16 is a flowchart showing a parameter setting routine in the third embodiment.

FIG. 17 is a flowchart showing a roulette control routine executed by a game machine according to a fourth embodiment of the present invention.

### DESCRIPTION OF EMBODIMENTS

### First Embodiment

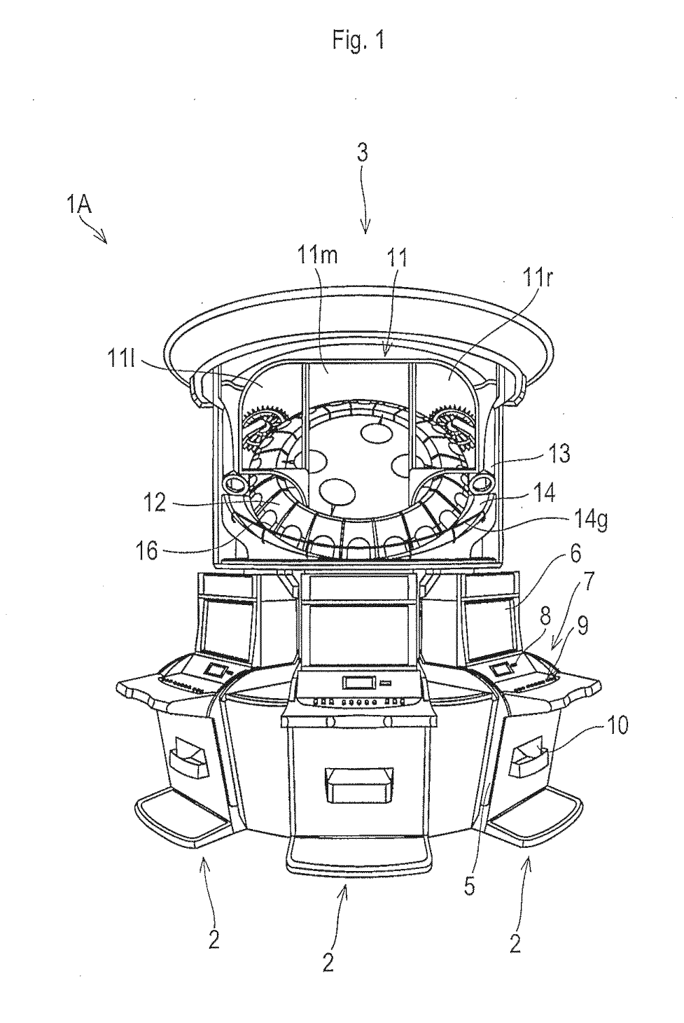

Hereinafter, a game machine according to a first embodiment of the present invention will be described with reference to drawings. FIG. 1 is an external appearance view of a game machine according to a first embodiment of the present invention. As shown in FIG. 1, the game machine 1A includes three station units 2 and a center unit 3. The three station units 2 are arranged around the center unit 3. In addition, although the three station units 2 are installed as seen in FIG. 1, the number of station units 2 may be an appropriate number. For example, the number of station units 2 may be one (1).

For example, the station unit 2 provides a slot game in exchange for consumption of coins as a game value. The slot game refers to a well-known game in which displays of symbols change according to a lottery result, and a predetermined privilege is given when a combination of changed displays of symbols forms a predetermined winning arrangement. The station unit 2 includes a housing 5. A station monitor 6 as a station display device is provided on a front surface of the housing 5. A game screen GS for executing a slot game is displayed on the station monitor 6. For example, a liquid crystal display (LCD) device is used as the station monitor 6. A control panel 7 is provided below the station monitor 6. The control panel 7 includes a coin slot 8 and an operation device 9. For example, the operation device 9 includes an operation member such as a button switch for performing various operations such as a bet operation. A coin-payout opening 10 is provided below the control panel 7.

Meanwhile, the center unit 3 provides a so-called roulette game (an opportunity of a lottery) through the station unit 2 when a predetermined game condition is satisfied. The roulette game refers to a well-known game in which a lottery is executed using a circular roulette wheel and a ball that rotates along the outer circumference of the roulette wheel. Typically, the roulette wheel includes pockets for accommodating a ball, and the pockets are provided along the outer circumference of the roulette wheel. And, a privilege is provided according to a pocket into which a ball has gone. For example, a condition whose requirement is satisfied when specific symbols form a winning arrangement in a slot game is employed as the predetermined game condition. However, the predetermined game condition is not limited to this. For example, various conditions related to the slot game such as a condition satisfied when a winning arrangement is formed a predetermined number of times or more, or a condition satisfied when a specific winning arrangement is formed may be used as the predetermined game condition. Alternatively, when a game other than a slot game is executed by the station unit 2, various conditions related to the game may be employed as the predetermined game condition.

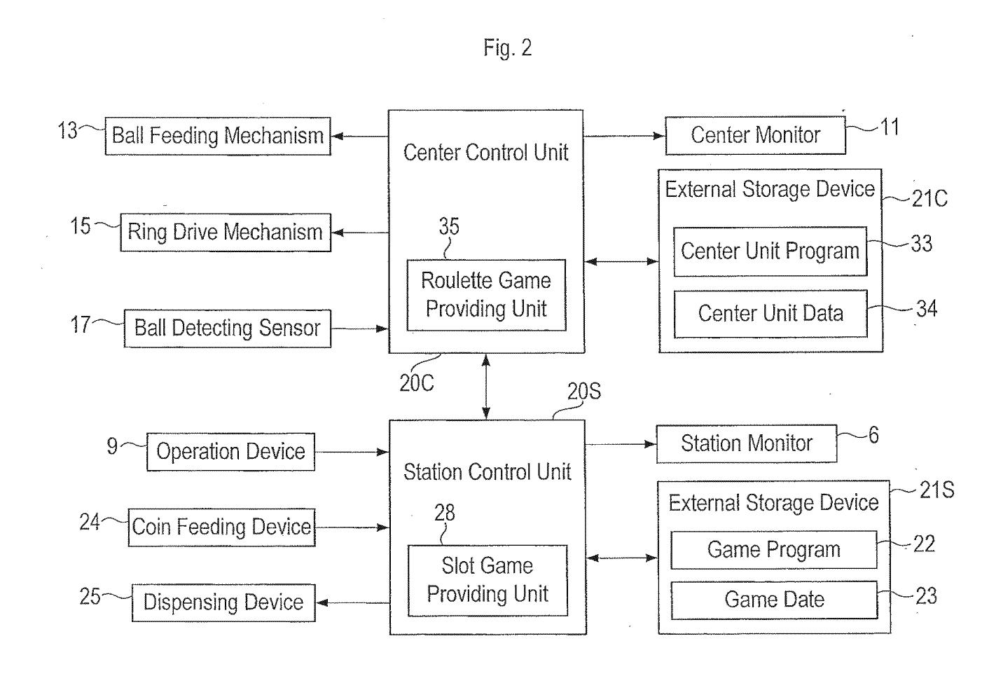

The center unit 3 includes a center monitor 11 as a center display device and a roulette game unit RG as a physical lottery mechanism. The roulette game unit RG includes a roulette ring 12, a ball feeding mechanism 13, and a ball guidepath 14. The roulette ring 12 is arranged such that a front side (a side at which the station unit 2 is arranged) of the roulette ring 12 is positioned downwardly, a rear side of an opposite side thereto is positioned upwardly, and so the roulette ring 12 is inclined. Further, the roulette ring 12 is arranged below the center monitor 11 so that the rear side of the roulette ring 12, that is, an upper portion of the inclination is hidden by the center monitor 11. The roulette ring 12 is rotationally driven in a predetermined direction at a predetermined speed by a ring drive mechanism 15 as shown in FIG. 2. Pockets 16 as first choices are provided around the roulette ring 12. Each of the pockets 16 is associated with a predetermined privilege.

The ball feeding mechanism 13 is a mechanism for feeding a ball B as a physical lottery medium to the ball guidepath 14. In other words, the ball B is fed to the ball guidepath 14 by the ball feeding mechanism 13. The ball guidepath 14 is formed so as to be extended along the outer circumference of the roulette ring 12. A guard 14g for limiting the movement of the ball B is provided at an outer circumference side of the ball guidepath 14, that is, the opposite side of the roulette ring 12. The guard 14g limits the movement of the ball B to prevent the ball B from straying from the ball guidepath 14. That is, the ball guidepath 14 is formed to limit the moving range of the ball B fed by the ball feeding mechanism 13 to a certain range so as to be able to guide the ball B to the pocket 16 of the roulette ring 12. A ball detecting sensor 17 as shown in FIG. 2 is provided in each of the pockets 16 so that the pocket 16 into which the ball B has gone can be detected.

Meanwhile, the center monitor 11 includes three monitors 111, 11m, and 11r. These three monitors 111, 11m, and 11r are used so as to function as one center monitor. These monitors 111, 11m, and 11r are represented as the center monitor 11 when it is not necessary to separate them. The center monitor 11 displays an image for making up for the hidden portion of the roulette ring 12. Specifically, as shown in FIG. 1, the center monitor 11 displays an image corresponding to the hidden portion of the roulette ring 12 such that the image has continuity with the roulette ring 12. With the rotation of the roulette ring 12, an image corresponding to the roulette ring 12 displayed on the center monitor 11 rotates so as to virtually show the rotation of the roulette ring 12. Similarly, when the roulette ring 12 stops, the image corresponding to the roulette ring 12 displayed on the center monitor 11 also stops. The display of the image is realized by simulating operations of the roulette ring 12, that is, rotation and stop of the roulette ring 12.

When a roulette game starts, the roulette ring 12 starts the rotation. Also, the ball B is fed to the ball guidepath 14 by the ball feeding mechanism 13. The fed ball B moves along the ball guidepath 14. Since the roulette ring 12 is inclined such that the front side is positioned downwardly, the ball guidepath 14 is similarly inclined. Thus, the fed ball B moves toward the opposite side of the ball feeding mechanism 13 along the ball guidepath 14, but the ball B changes its moving direction in the middle of the inclination and moves to return to the side of the ball feeding mechanism 13. After this movement is repeated several times, the moving range of the ball B converges to the lowermost position of the ball guidepath 14, that is, the lowermost position of the roulette ring 12. Then, the ball B goes into any one of the pockets 16 (mainly, the pocket 16 at the lowermost position at an appropriate time) of the roulette ring 12 at an appropriate time. A player is given a predetermined privilege associated with the pocket 16 into which the ball has gone.

Next, a configuration of a control system of the game machine 1A will be described with reference to FIG. 2. FIG. 2 is a functional block diagram describing a schematic configuration of a control system of the game machine 1A. As shown in FIG. 2, the game machine 1A includes a center control unit 20C and a station control unit 20S. The station control unit 20S is configured as a computer unit that controls the station unit 2. Specifically, the station control unit 20S is configured as a computer unit that includes a microprocessor, a main storage device necessary for an operation thereof, and other peripheral devices. The station control unit 20S is provided for each station unit 2 as a component of the station unit 2. The center control unit 20C and each station control unit 20S are connected to each other so that transmission and reception of information can be performed therebetween.

Further, the station control unit 20S is connected to an external storage device 21S. As the external storage device 21S, for example, there is used a storage medium that can retain stored information without a power supply including a magnetic storage medium such as a hard disk (HD), an optical storage medium such as a digital versatile disc read only memory (DVD-ROM), a non-volatile semiconductor memory such as electrically erasable programmable read only memory (EEPROM), and the like.

The external storage device 21S stores a game program 22 and game data 23. The game program 22 refers to a program necessary for the station unit 2 to execute a slot game. The game data 23 refers to a variety of data used when the game program 22 is executed. The game program 22 is appropriately read and executed by the station control unit 20S. The game data 23 is appropriately read and referred by the station control unit 20S. The game program 22 includes a variety of program modules necessary for executing a game, but the program modules are not shown in the figure. Similarly, the game data 23 further includes a variety of data such as reel data, sound effect data, and dividend data, but these data are also not shown in the figure.

As the game program 22 is executed, a slot game providing unit 28 is provided in the station control unit 20S. The slot game providing unit 28 executes a process necessary for the station unit 2 to provide a slot game. For example, the slot game providing unit 28 executes processes such as a process of changing a display of symbols, a process of generating a random number with a predetermined number of digits, a process of selecting symbols to be displayed after a change using the random number by lottery, and a process for determining whether or not a combination of symbols after a change has formed a winning arrangement. The slot game providing unit 28 is a logical device implemented by a combination of a microprocessor and software. In addition, a random number may be generated by a physical device into which an electronic circuit is incorporated. Further, a logical device or a physical device necessary for implementing a slot game is appropriately provided in the station control unit 20S; however, both of the devices are not shown in the figure.

Further, the station control unit 20S is connected to the operation device 9 and the station monitor 6. The operation device 9 outputs a signal corresponding to a player's operation to the station control unit 20S. The station monitor 6 displays an image corresponding to an image signal output from the station control unit 20S. The station control unit 20S executes a game in a predetermined sequence according to the game program 22 with reference to the output signal of the operation device 9. By doing so, the station control unit 20S causes a game screen corresponding to a status of a slot game to be displayed on the station monitor 6.

Further, the station control unit 20S is connected to a coin feeding device 24 and a dispensing device 25 which function as an input device and an output device necessary for executing a slot game, respectively. The coin feeding device 24 receives a coin in exchange for playing a game through the coin slot 8. Then, the coin feeding device 24 outputs a signal corresponding to the amount of fed coins to the station control unit 20S.

The dispensing device 25 pays coins to a player as a dividend of a game according to an instruction from the station control unit 20S. A coin is paid through the coin-payout opening 10. In addition, a payment to be received and a dividend for a player are not limited to a coin. For example, a medal, a token, or the like may be used as an alternative currency. Or, an accounting method capable of exchanging a currency value or a game value through an exchange of an electronic currency or other electronic information may be used. In this case, an information communication device for mutually exchanging electronic information, a storage medium for storing exchanged information, and the like may be used instead of the coin slot 8 and the coin-payout opening 10.

Meanwhile, the center control unit 20C is configured as a computer unit that controls the center unit 3. Specifically, the center control unit 20C is configured as a computer unit that includes a microprocessor, a main storage device necessary for an operation thereof, and other peripheral devices. The center control unit 20C is connected to the center monitor 11, the ring drive mechanism 15, the ball feeding mechanism 13, and the ball detecting sensor 17 described above.

Further, the center control unit 20C is connected to an external storage device 21C. As the external storage device 21C, for example, there is used a storage medium that can retain stored information without power supply including a magnetic storage medium such as a HD, an optical storage medium such as a DVD-ROM, a non-volatile semiconductor memory such as EEPROM, and the like. In addition, various devices such as a vibration detecting sensor for detecting a vibration (shaking) occurring in the center unit 3 are further connected to the center control unit 20C, but they are omitted in the figure.

The external storage device 21C stores a center unit program 33 and center unit data 34. The center unit program 33 refers to a program necessary for the center unit 3 to execute the roulette game. The center unit data 34 refers to a variety of data used when the center unit program 33 is executed. The center unit program 33 is appropriately read and executed by the center control unit 20C. The center unit data 34 is appropriately read and referred by the center control unit 20C. The center unit program 33 includes a variety of program modules necessary for executing a roulette game. Similarly, the center unit data 34 further includes a variety of data such as sound effect data, dividend data, and data for associating each of the pockets 16 with a predetermined privilege; however, both the programs and the data are not shown in the figure.

As the center unit program 33 is executed, a roulette game providing unit 35 is provided in the center control unit 20C. The roulette game providing unit 35 executes a process necessary for the center unit 3 to provide the roulette game. For example, the roulette game providing unit 35 executes a variety of processes such as a process for controlling the ball feeding mechanism 13, a process for controlling the ring drive mechanism 15, and the like.

The ring drive mechanism 15 includes an electric motor (not shown). The roulette ring 12 is rotated by the electric motor. The center control unit 20C controls the electric motor by pulse width modulation (PWM) control. In the well-known PWM control, the ratio of the period taken to supply power within a predetermined period, so-called duty ratio, is changed, thereby controlling the electric motor and the like. When the duty ratio is 100%, the most power is supplied to the electric motor. And, the power supplied to the electric motor is decreased as the duty ratio is decreased. When the duty ratio is 0%, power supply to the electric motor stops.

The center control unit 20C controls the rotation of the roulette ring 12 by changing the duty ratio. The center control unit 20C changes the duty ratio to a predetermined lottery start value (for example, 50%, 100%, and the like) setting at the start of the lottery, when the above predetermined game condition is satisfied. Thereby, the roulette ring 12 starts to rotate and the roulette game is started. Then, when a ball B is fed, the center control unit 20C decreases the duty ratio gradually at predetermined deceleration interval DI. Thereby, the roulette ring 12 is decelerated gradually. For example, 2 seconds is set as the deceleration interval DI. When the ball B enters any one of the pockets 16, the center control unit 20C changes the duty ratio to 0%.

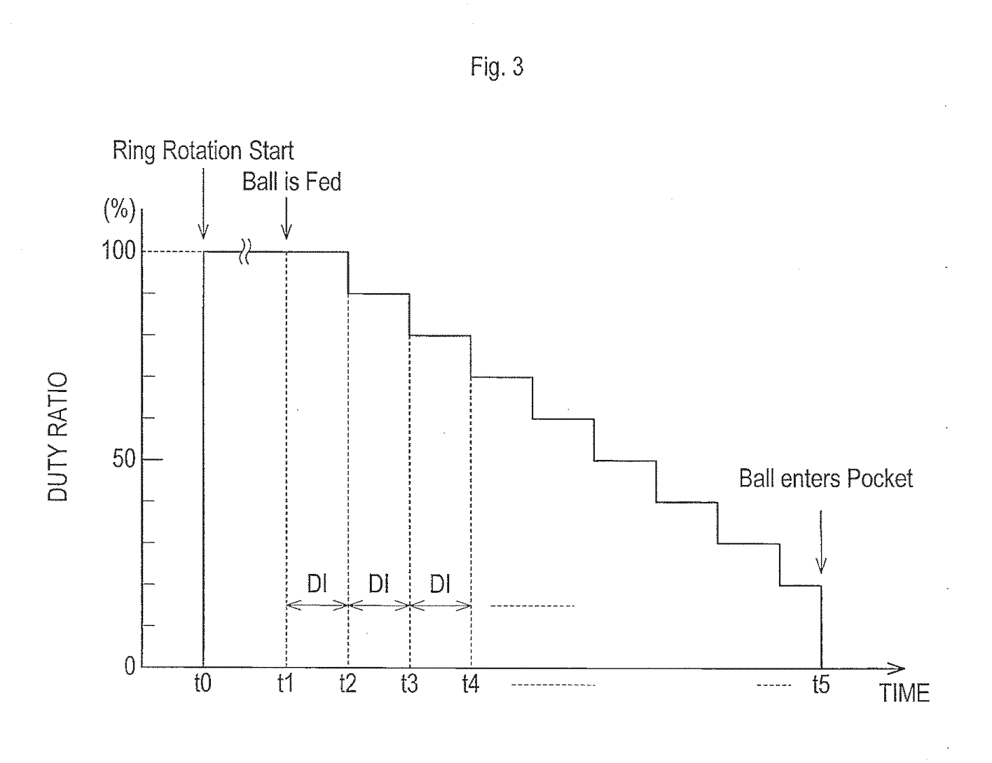

FIG. 3 shows an example of such temporal variations of the duty ratio. In this example, the predetermined game condition is satisfied at time t0, and the duty ratio of the ring drive mechanism 15 is changed to 100% as the lottery start value. Then when the ball B is fed at time t1, the duty ratio is changed to 90% at time t2 at which the deceleration interval DI has passed from time t1. After this, as shown in FIG. 3, in this example, the duty ratio decreases 10% every time the deceleration interval DI elapses. In this example, the ball B enters the pocket 16 at time t5. Thus, the duty ratio is changed to 0% at time t5.

In addition, the center control unit 20C adjusts the deceleration interval DI properly so that the time taken for one game (lottery time) falls within a predetermined target range when executing a roulette game as described above. The lottery time is a period from the time at which the ball B is fed to the time at which the ball B enters any one of the pockets 16. That is, the period from time t1 to time t5 in FIG. 3 corresponds to the lottery time. The deceleration interval DI is adjusted depending on the lottery times of games up to the previous game. For example, the deceleration interval DI is decreased in a case that an average value of the lottery times of games up to the previous game (hereinafter, referred to as an average lottery time) is greater than an upper limit of the target range. On the other hand, the deceleration interval DI is increased in a case that the average lottery time of games up to the previous game is less than a lower limit of the target range. The adjustment of the deceleration interval DI is executed before a roulette game starts. After the roulette game has started, it is prohibited to adjust the deceleration interval DI until the game ends. That is, in this game machine 1A, the deceleration interval DI is not changed while the roulette game is being executed. In this embodiment, it is shown an example that the target range of the lottery time is set at or above 20 seconds and at or below 30 seconds.

In order to adjust the deceleration interval DI as described above, the number of times when the roulette game is executed (hereinafter, referred to as the number of times of lottery) and average lottery time are stored in the main storage device of the center control unit 20C and are updated every time a roulette game is executed. Further, these values may be reset to 0 when the center control unit 20C is started. In addition, these values may be backed up and may be reset when the data of the main storage device is cleared.

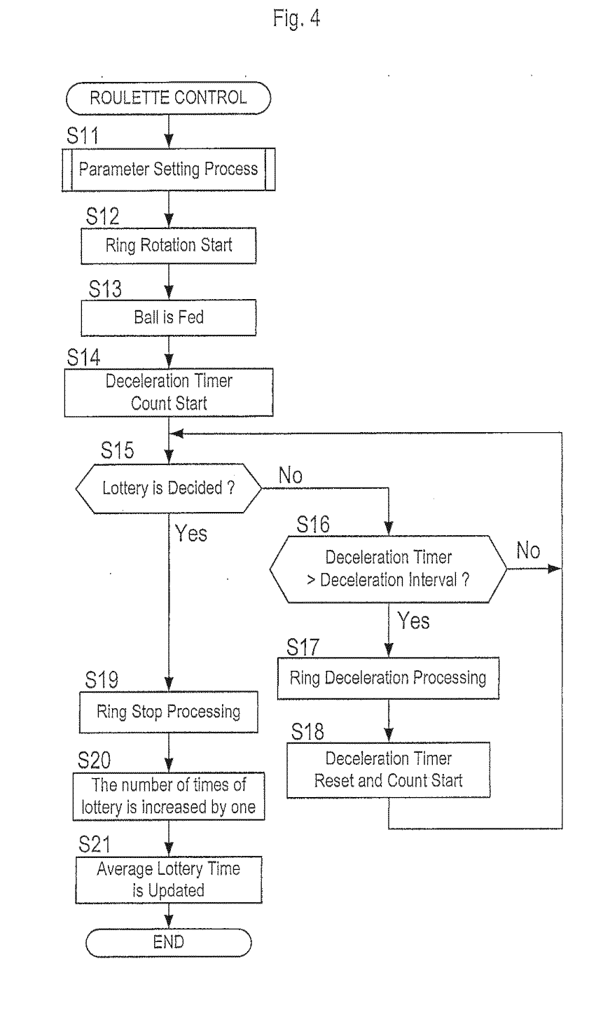

FIG. 4 shows a roulette control routine which is executed by the center control unit 20C in order to control the roulette game unit RG in this manner. This control routine is executed when the above-mentioned predetermined game condition is satisfied.

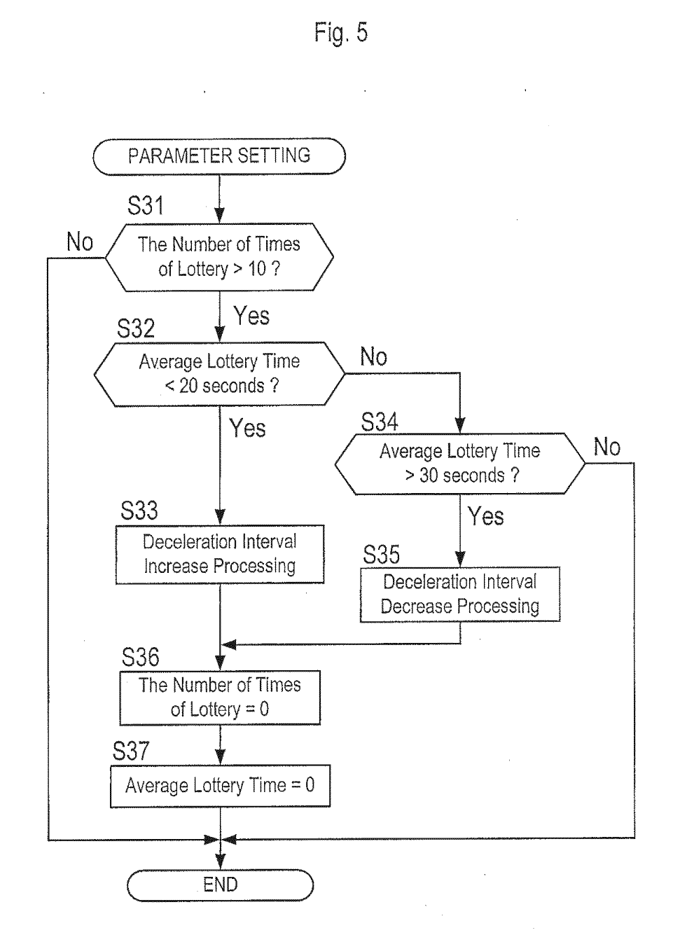

In this control routine, the center control unit 20C first executes a parameter setting process at step S11. In the parameter setting process, a parameter setting routine as shown in FIG. 5 is executed. In the following description, 10 times, 20 seconds, 0.1 seconds and the like are examples of values of the number of times and the times of this embodiment. The number of times and the times are not limited to the above values.

In the routine of FIG. 5, the center control unit 20C determines whether or not the number of times of lottery is greater than 10 at step S31. If the center control unit 20C determines that the number of times of lottery is 10 or less, the center control unit 20C ends the current routine. On the other hand, if the center control unit 20C determines that the number of times of lottery is greater than 10, the center control unit 20C proceeds to step S32 and determines whether or not the average lottery time is less than 20 seconds. If the center control unit 20C determines that the average lottery time is less than 20 seconds, the center control unit 20C proceeds to step S33 and executes a deceleration interval increase processing. For example, in this processing, a predetermined correction value is added to the deceleration interval DI. 0.1 seconds is set to the correction value. The correction value is not limited to 0.1 seconds, and any suitable value may be set.

On the other hand, if the center control unit 20C determines that the average lottery time is 20 seconds or more, the center control unit 20C proceeds to step S34 and determines whether or not the average lottery time is greater than 30 seconds. If the center control unit 20C determines that the average lottery time is 30 seconds or less, the center control unit 20C ends the current routine. On the other hand, if the center control unit 20C determines that the average lottery time is greater than 30 seconds, the center control unit 20C proceeds to step S35 and executes a deceleration interval decrease processing. For example, in this processing, a predetermined correction value is subtracted from the deceleration interval DI. 0.1 seconds is set to the correction value. The correction value is not limited to 0.1 seconds, and any suitable value may be set.

After changing the deceleration interval DI at step S33 or step 35, the center control unit 20C proceeds to step S36 and sets the number of times of lottery to 0. At the next step S37, the center control unit 20C sets the average lottery time to 0. Thereafter, the center control unit 20C ends the current routine.

Returning to FIG. 4, the description of the roulette control routine will be continued. At the next step S12, the center control unit 20C rotates the roulette ring 12. Specifically, as described above, the duty ratio of the ring drive mechanism 15 is changed to the lottery start value (for example, 50%, 100%, and the like). Thereby, the roulette ring 12 is accelerated to a predetermined lottery start speed. At the next step S13, the center control unit 20C feeds the ball B. Then, at the next step S14, the center control unit 20C resets a deceleration timer and then starts the count of the deceleration timer. For the deceleration timer, a timer which can measure at intervals of at least 0.1 seconds is used.

At the next step S15, the center control unit 20C determines whether or not a lottery is decided in the roulette game, that is, whether or not the ball B has entered any one of the pockets 16. This determination may be made based on the output signal of the ball detecting sensor 17. If the center control unit 20C determines that the lottery is not decided, the center control unit 20C proceeds to step S16 and determines whether or not the value of the deceleration timer is greater than the deceleration interval DI. If the center control unit 20C determines that the value of the deceleration timer is less than the deceleration interval DI, the center control unit 20C returns to step S15. On the other hand, if the center control unit 20C determines that the value of the deceleration timer is greater than the deceleration interval DI, the center control unit 20C proceeds to step S17 and executes a ring deceleration processing. In this ring deceleration processing, as described above, the duty ratio is decreased to a predetermined value, 10% for example. If the duty ratio is already lower than a lower limit duty ratio at the time of the lottery (for example, 20%), the value is maintained. At the next step S18, the center control unit 20C resets the deceleration timer and starts the count of the deceleration timer. Then, the center control unit 20C returns to step S15.

On the other hand, if the center control unit 20C determines that a lottery is decided in a roulette game, the center control unit 20C proceeds to step S19 and executes a ring stop processing. In this ring stop processing, the duty ratio is set to 0%. At the next step S20, the center control unit 20C increases the number of times of lottery by one. At the next step S21, the center control unit 20C updates the average lottery time based on the lottery time of the game of this round. Thereafter, the center control unit 20C ends the current control routine. After being updated, the number of times of lottery and the average lottery time are stored in the main storage device of the center control unit 20C as described above. And they are referred when this control routine is executed to the next time.

As is well known, in the physical lottery mechanism, the movement and the like of the roulette ring 12 are changed with time. Thereby, there is a possibility that variation of the lottery time increases. According to the first embodiment, since the deceleration interval DI is changed depending on the average lottery time, it is possible to decrease the variation of the lottery time. For example, the deceleration interval DI is changed based on the average lottery time of at least 10 nearest lotteries. In other words, the deceleration interval DI is changed by feedback of the lottery time of at least 10 nearest lotteries. Thereby, the deceleration interval DI can be changed appropriately.

Further, when the rotation speed of the roulette ring 12 is constant and the rotation of the roulette ring 12 matches the cycle of the flipping motion of the ball B, there is a possibility that it becomes difficult for the ball B to enter the pocket 16. In such a case, the lottery time increases. In the first embodiment, such matching of the cycle can be prevented since the rotation speed of the roulette ring 12 is decelerated at every deceleration interval DI. Thus, it is possible to prevent the lottery time from being prolonged.

And, since the deceleration interval DI is changed based on the average of the lottery time of at least 10 nearest lotteries, for example, the lottery time is not changed significantly. Thereby, it is possible to change the lottery time to an optimum lottery time without being known to the player. In addition, since the rotation speed of the roulette ring 12 is decreased gradually, it is informed to the player that it has become easy for the ball B to enter the pocket 16, and it is possible to arouse the player's interest. Especially in such a situation, it is possible to arouse the player's interest even more if the pocket 16 of high dividend passes the lowest part.

As described above, the deceleration interval DI is changed before starting the roulette game, and is not changed while the roulette game is being executed. Thereby, it is possible to prevent the rotation speed of the roulette ring 12 from changing unnaturally.

For example, the deceleration interval DI is not changed until the number of times of lottery is more than 10. The predetermined number of times of lottery for determining the change of the deceleration interval DI is not limited to 10. The number of times which can strike a probable average is set the predetermined number of times of lottery in order to strike an average of the variation of the lottery time of the physical lottery.

In the first embodiment described above, the roulette ring 12 is decelerated by changing the duty ratio of the ring drive mechanism 15, but the method of decelerating the roulette ring 12 is not limited thereto. For example, a brake which can brake the electric motor or the roulette ring 12 may be provided. And, the roulette ring 12 may also be decelerated by operating the brake at every deceleration interval DI.

### Second Embodiment

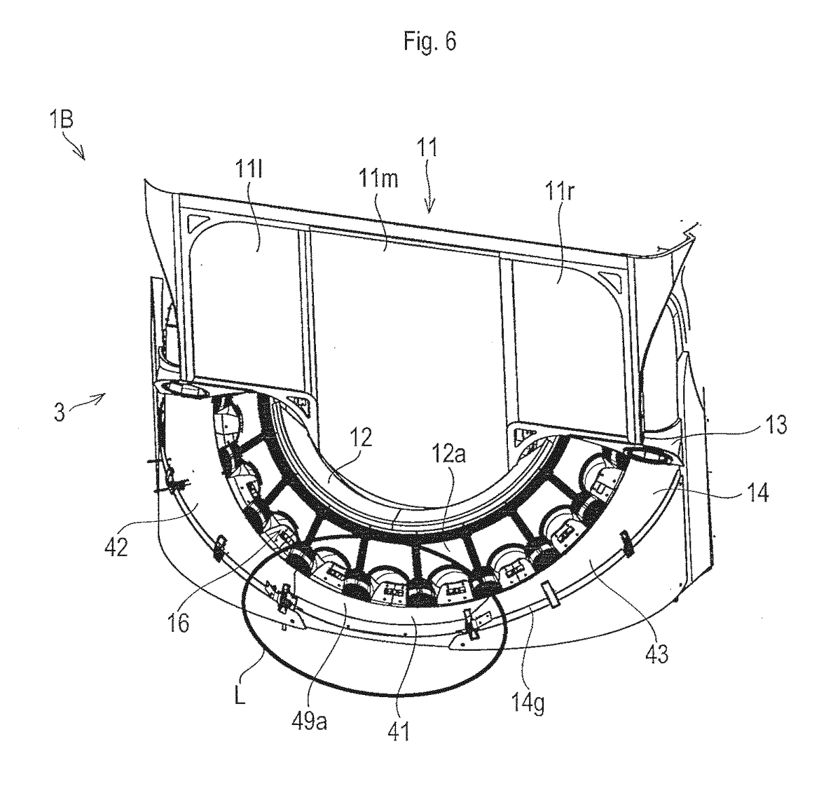

A game machine according to the second embodiment of the present invention will be described with reference to FIGS. 6 to 11. In this embodiment, the same components as those in the first embodiment are denoted by the same reference numeral, and descriptions thereof will be omitted. FIG. 6 is an enlarged view showing a part of the center unit 3 of the game machine 1B according to the second embodiment. As shown in FIG. 6, a center slope 41 encircled by a line L, a left slope 42, and a right slope 43 are provided on the outer circumference of the roulette ring 12. In addition, the ball guidepath 14 is formed by these three slopes 41, 42 and 43. As shown in FIG. 6, the center slope 41 is disposed at the lowest position in the ball guidepath 14. One end of the left slope 42 in the circumferential direction is attached to the center slope 41, and the other end is fixed to a base portion (not shown) of the center unit 3. Likewise, one end of the right slope 43 in the circumferential direction is attached to the center slope 41, and the other end is fixed to the base portion of the center unit 3. The left slope 42 and the right slope 43 are attached to the center slope 41 such that there is no stepped portion on the ball guidepath 14.

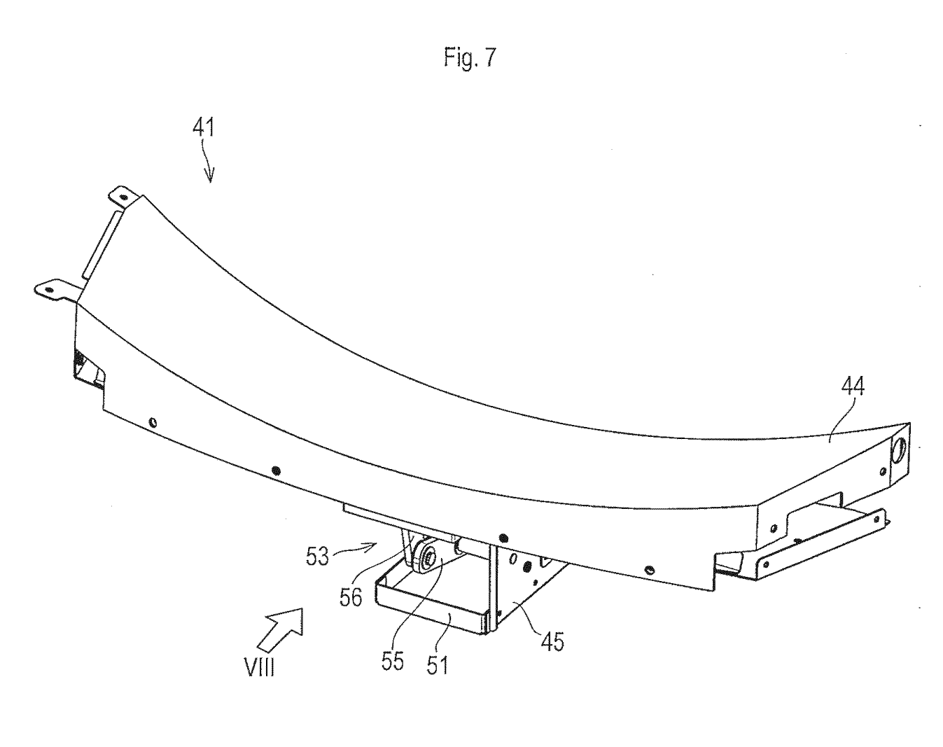

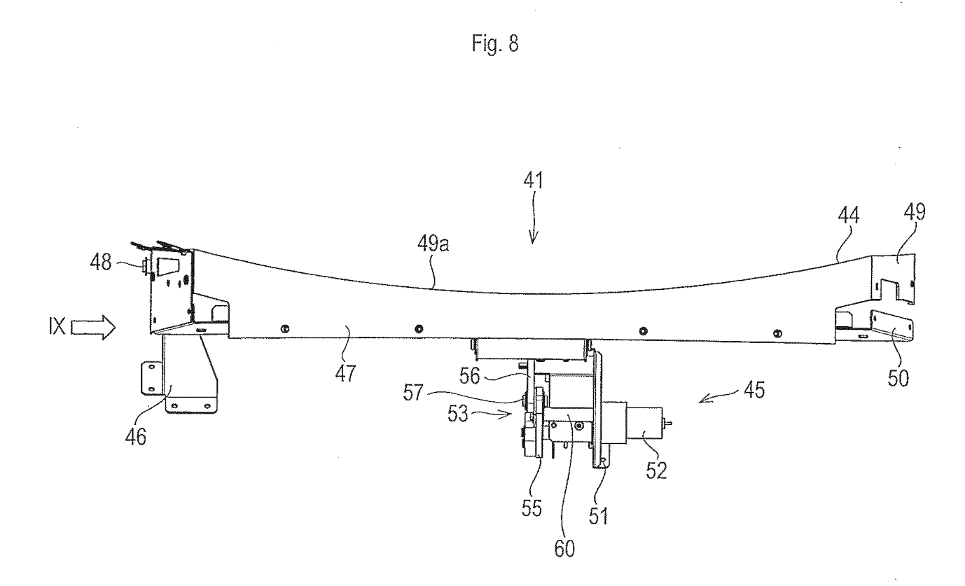

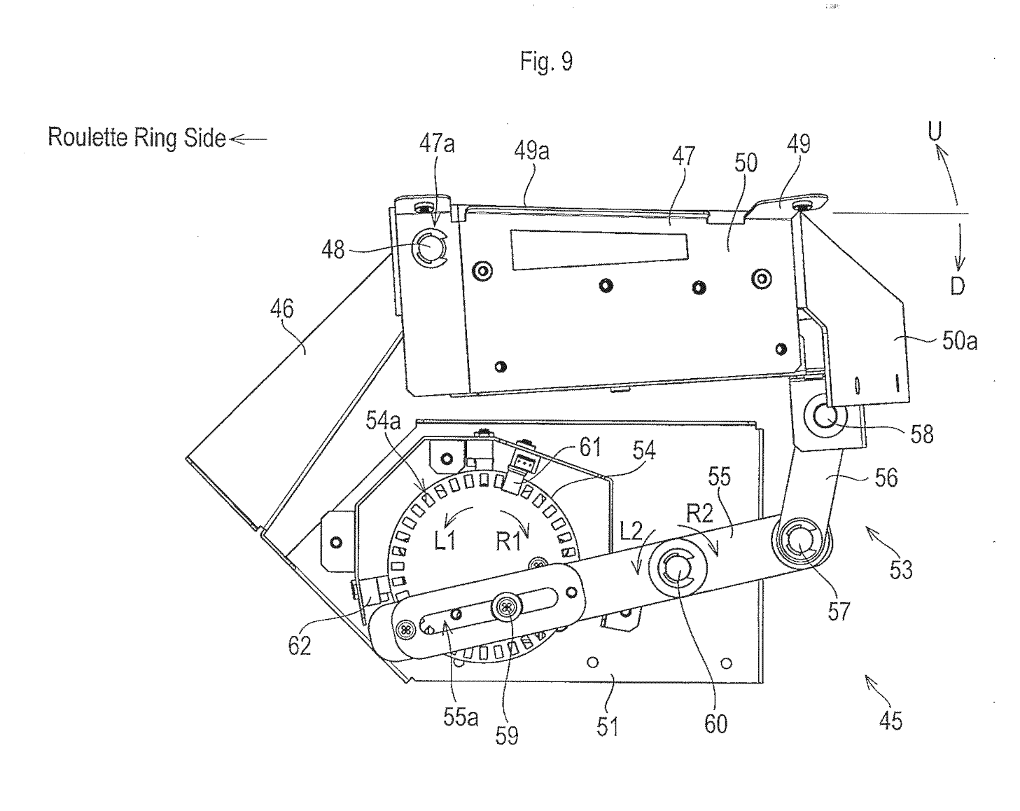

FIG. 7 is an enlarged perspective view showing the center slope 41. FIG. 8 is a view showing the center slope 41 viewed in a direction of an arrow VIII in FIG. 7. FIG. 9 is a view showing the center slope 41 viewed in a direction of an arrow IX in FIG. 8.

Below, for the sake of convenience, the inner side of the ball guidepath 14, that is, the roulette ring 12 side, will be called an inner circumference side, and the outer side of the roulette ring 14, that is, the opposite side of the roulette ring 12, will be called an outer circumference side.

As shown in FIGS. 7 to 9, the center slope 41 includes a slope portion 44 and a slope angle changing mechanism 45 disposed under the slope portion 44. As shown in FIGS. 8 and 9, the slope portion 44 includes a fixing member 46 and a movable member 47. The fixing member 46 is fixed to the base portion of the center unit 3. As shown in FIG. 9, the fixing member 46 is provided on a position closer to the roulette ring 12 than the movable portion 47. At an end portion of the outer circumference side of the fixing member 46, a spindle 48 is provided. The spindle 48 is inserted into a through hole 47a formed in the movable portion 47. The through hole 47a extends in the left and right directions of FIG. 8. The through hole 47a is formed at an end portion on the inner circumference side of the movable portion 47. As shown in FIG. 8, the through hole 47a is formed at one end of the movable portion 47 in the circumferential direction. The movable portion 47 is supported by the fixing member 46 so as to be swingable about the spindle 48 in an arrow U direction and in an arrow D direction in FIG. 9. A movable range is set in the movable member 47. As the movable range, for example, 4° in each of the arrow U direction and the arrow D direction from a reference position as shown in FIG. 9, that is, the range of reference position ±4° is set.

The movable portion 47 includes a track member 49 and a support member 50 for supporting the track member 49. As is clear from FIG. 6, the ball B travels on an upper surface 49a of the track member 49. As shown in the FIG. 6, the circumferential length of the upper surface 49a is set a length which is greater than one of the pockets 16 (for example, three of the pockets 16). As shown in FIG. 7, the upper surface 49a is formed in such a way that the central portion is lowest and it becomes gradually higher toward the left and right from the central portion. The support member 50 is attached to the downside of the track member 49. The through hole 47a is formed in the support member 50. As shown in FIG. 9, a guard attaching portion 50a which is attached the guard 14g is provided at the end portion on the outer circumference side of the support member 50. Hereinafter, the upper surface 49a of the track member 49 will also be referred to as a ball traveling surface.

As shown in FIG. 8, the slope angle changing mechanism 45 is disposed at the downside of a central portion of the slope portion 44. The slope angle changing mechanism 45 changes an angle of the ball traveling surface (hereinafter, referred to as a slope angle) with respect to the horizontal plane by swinging the movable portion 47 about the spindle 48. Thereby, an angle between an upper surface 12a of the roulette ring 12 and the ball traveling surface is changed. Accordingly, the slope angle changing mechanism 45 corresponds to an angle changing mechanism of the present invention.

As shown in FIG. 9, the slope angle changing mechanism 45 includes a base member 51, an electric motor 52 and a link mechanism 53. The base member 51 is fixed to the base portion of the center unit 3. The electric motor 52 is fixed to the base member 51. As the electric motor 52, a stepping motor, for example, in which the rotation angle of an output shaft can be adjusted with a high degree of accuracy, is used. A rotating disk 54 is mounted coaxially on an output shaft (not shown) of the electric motor 52. The link mechanism 53 is provided in order to convert a rotation motion of the electric motor 52 to a swinging motion of the movable portion 47.

The link mechanism 53 includes a first link member 55 and a second link member 56. One end of the first link member 55 and one end of the second link member 56 are connected to each other rotatably via a pin 57. The other end of the second link member 56 is connected to the movable portion 47 rotatably via a pin 58. As shown in FIG. 9, the second link member 56 is connected to the end portion on the outer circumference side of the movable portion 47. An elongate hole 55a is formed in the other end portion of the first link member 55. A bolt 59 is inserted into the elongate hole 55a. The other end portion of the first link member 55 is mounted on the rotating disk 54 by the bolt 59. The bolt 59 is inserted into the elongate hole 55a such that it can make relative movement with respect to the first link member 55. Thereby, the bolt 59 can slide in the elongate hole 55a. On the other hand, the bolt 59 is fixed on the rotating disk 54. Thereby, the bolt 59 rotates together with the rotating disk 54. A spindle 60 is provided on the base member 51. As shown in FIG. 8, the spindle 60 extends in the direction in which the output shaft of the electric motor 52 extends, that is, the left and right directions of FIG. 8. The first link member 55 is rotatably supported by the spindle 60. The spindle 60 supports the middle portion between one end of the first link member 55 and the elongate hole 55a.

In the slope angle changing mechanism 45, when the rotating disk 54 rotates in an arrow R1 direction from the position shown in FIG. 9, that is, clockwise, the first link member 55 rotates about the spindle 60 in an arrow L2 direction, that is, counterclockwise. Thereby, the second link member 56 is pushed upward, and the movable portion 47 swings about the spindle 48 in the arrow U direction. In this case, since the outer circumference side of the movable portion 47 goes up, the slope angle of the ball traveling surface increases. On the other hand, when the rotating disk 54 rotates in an arrow L1 direction from the position shown in FIG. 9, that is, counterclockwise, the first link member 55 rotates about the spindle 60 in an arrow R2 direction, that is, clockwise. Thereby, the second link member 56 is pulled downward, and the movable portion 47 swings about the spindle 48 in the arrow D direction. In this case, since the outer circumference side of the movable portion 47 goes down, the slope angle of the ball traveling surface decreases. Thus, the rotating disk 54, the first link member 55, the second link member 56 and the movable portion 47 are linked. For example, the slope angle changing mechanism 45 is configured such that the slope angle can be changed in units of 0.1°.

As described above, one end of the left slope 42 and one end of the right slope 43 are respectively attached to the center slope 41. Thereby, if the movable portion 47 is moved in this manner, the left slope 42 and the right slope 43 are properly bent according to the movement of the movable portion 47. That is, if the movable portion 47 swings, the whole of the ball guidepath 14 is deformed to be bent. Accordingly, a stepped portion is not formed on the ball guidepath 14.

The slope angle changing mechanism 45 is provided with a rotation detecting sensor 61 and a reference position detecting sensor 62. As shown in FIG. 9, a plurality of detection holes 54a are formed on the outer circumference portion of the rotating disk 54. The plurality of detection holes 54a are formed at regular intervals over the whole circumference. The rotation detecting sensor 61 is mounted on the base member 51 such that the plurality of detection holes 54a pass the front of the rotation detecting sensor 61 when the rotating disk 54 rotates. The rotation detecting sensor 61 outputs a signal every time the detection hole 54a passes in the front. As the rotation detecting sensor 61, a well-known rotary encoder, for example, may be used. Thereby, detailed description thereof will be omitted.

The reference position detecting sensor 62 is a sensor for detecting whether or not the movable portion 47 is at a reference position. The detection portion (not shown) of the reference position detecting sensor 62 is provided on the rotating disk 54. The reference position detecting sensor 62 is mounted on the base member 51 so as to detect the detection portion when the movable portion 47 is at the reference position. The reference position detecting sensor 62 outputs a signal when it detects the detection portion. On the other hand, the reference position detecting sensor 62 does not output a signal when it does not detect the detection portion. Thereby, it is possible to determine whether or not the movable portion 47 is at the reference position based on the presence or absence of the output signal.

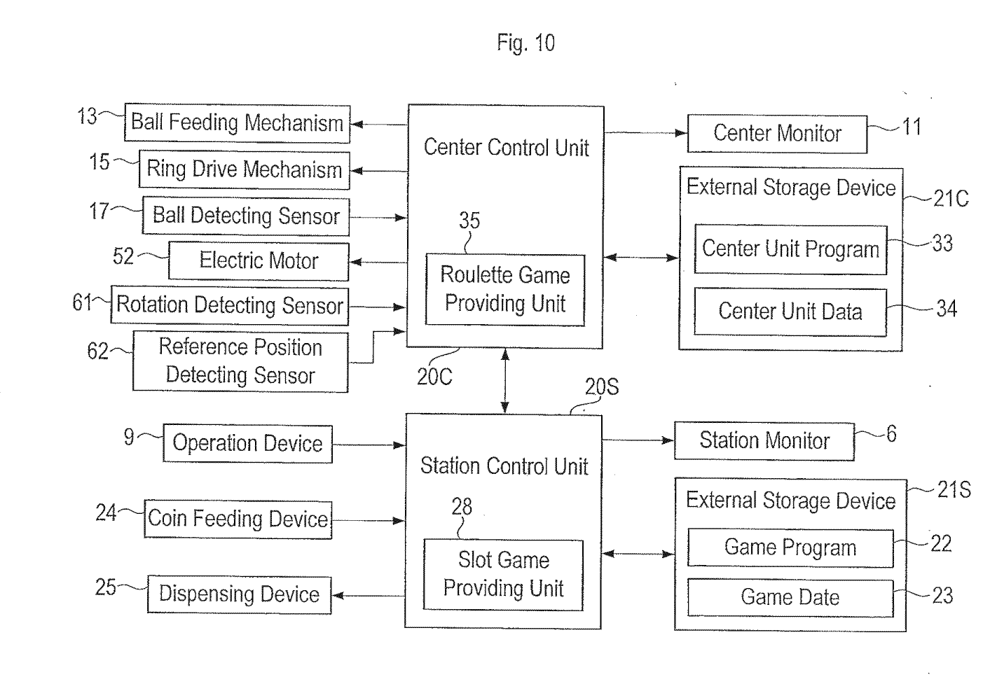

FIG. 10 is a view schematically showing a configuration of a control system of the game machine 1B. As shown in FIG. 10, the electric motor 52, the rotation detecting sensor 61 and the reference position detecting sensor 62 are connected to the center control unit 20C. The center control unit 20C controls the electric motor 52 based on the output signals of the rotation detecting sensor 61 and the output signals of the reference position detecting sensor 62. In this embodiment, the center control unit 20C properly adjusts the slope angle of the ball traveling surface so that the lottery time of the roulette game falls within the predetermined target range. If the movable portion 47 swings in the arrow U direction of FIG. 9, the slope angle of the ball traveling surface increases. In this case, the angle between the upper surface 12a of the roulette ring 12 and the ball traveling surface is decreased. As is clear from FIG. 6, in this case, it becomes easy for the ball B to go toward the inner circumference side, that is, toward the roulette ring 12 side, so it becomes easy for the ball B to enter the pocket 16. Thereby, the lottery time is decreased. On the other hand, if the movable portion 47 swings in the arrow D direction, the slope angle of the ball traveling surface decreases. In this case, the angle between the upper surface 12a of the roulette ring 12 and the ball traveling surface is increased. And, in this case, it becomes difficult for the ball B to go toward the inner circumference side, so it becomes difficult for the ball B to enter the pocket 16. Thereby, the lottery time is increased. The adjustment of the slope angle is executed before a roulette game starts. After the roulette game starts, the adjustment of the slope angle is prohibited until the game ends. That is, in this game machine 1B, the slope angle is not changed while the roulette game is being executed.

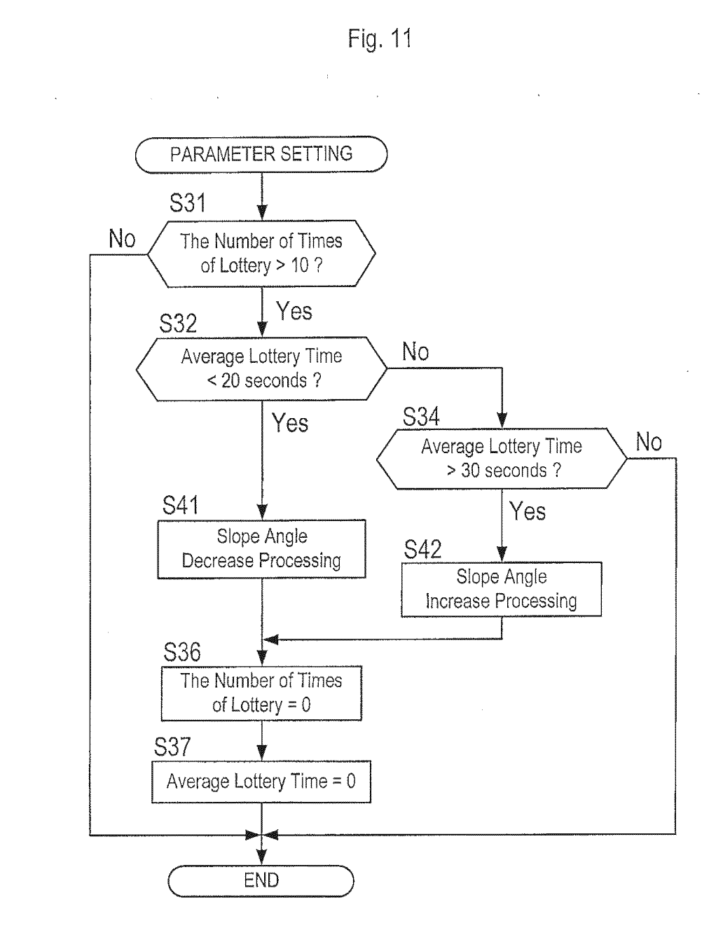

Also in this embodiment, the center control unit 20C executes the roulette control routine of FIG. 4 as in the first embodiment. However, in this embodiment, a parameter setting routine shown in FIG. 11 is executed in step S11. The routine of FIG. 11 will be described. In FIG. 11, the same processes as those in FIG. 5 are denoted by the same reference numeral as those in FIG. 5, and descriptions thereof will be omitted. In the following description, 10 times, 20 seconds, 0.1° and the like are examples of values of the number of times, the time and the angle of this embodiment. The number of times, the time and the angle are not limited to the above values.

In this routine, the center control unit 20C executes the processes until step S32 as with FIG. 5. In step S32, if the center control unit 20C determines that the average lottery time is less than 20 seconds, the center control unit 20C proceeds to step S41 and executes a slope angle decrease processing. In this processing, the electric motor 52 is controlled so that the slope angle of the ball traveling surface becomes smaller by a predetermined angle than the present value. Thereby, the angle between the upper surface 12a of the roulette ring 12 and the ball traveling surface is increased. As the predetermined angle, 0.1°, for example, is set. Further, the predetermined angle is not limited to 0.1°, and any proper value may be set. Thereafter, the center control unit 20C proceeds to step S36, and executes the processes as with FIG. 5.

On the other hand, if the center control unit 20C determines that the lottery time is 20 seconds or more, the center control unit 20C proceeds to step S34 and determines whether or not the average lottery time is greater than 30 seconds. If the center control unit 20C determines that the average lottery time is 30 seconds or less, the center control unit 20C ends the current routine. On the other hand, if the center control unit 20C determines that the average lottery time is greater than 30 seconds, the center control unit 20C proceeds to step S42 and executes a slope angle increase processing. In this processing, the electric motor 52 is controlled so that the slope angle of the ball traveling surface becomes larger by a predetermined angle than the present value. Thereby, the angle between the upper surface 12a of the roulette ring 12 and the ball traveling surface is decreased. As the predetermined angle, 0.1°, for example, is set. Further, the predetermined angle is not limited to 0.1°, and any suitable value may be set. Thereafter, the center control unit 20C proceeds to step S36, and executes the processes as with FIG. 5.

As described above, according to the game machine 1B of the second embodiment, the slope angle of the ball traveling surface, that is, the angle between the upper surface 12a of the roulette ring 12 and the ball traveling surface, is changed depending on the average lottery time, so it is possible to decrease the variation of the lottery time. Further, since the slope angle is changed based on the average lottery time of at least 10 nearest lotteries, it is possible to change the slope angle appropriately.

In this embodiment, a length corresponding to three of the pockets 16 is set as the circumferential length of the center slope 41. Thereby, compared with the case in which a length corresponding to one of the pockets, for example, is set, the section in which it is easy for the ball B to enter can be made larger. By changing the slope angle of the section of the length corresponding to three of the pockets 16 as described above, unnaturalness can be alleviated. In this embodiment, the circumferential length of the center slope 41 is not limited to the length corresponding to three of the pockets 16. A length which is greater than one of the pockets 16, for example, three-and-a-half of the pockets 16, four or more of the pockets 16 or the like, may be set as the length of the center slope 41.

The slope angle of the ball traveling surface is changed before starting the roulette game, and is not changed while the roulette game is being executed. Thereby, it is possible to prevent the movement of the ball B from unnaturally changing during the roulette game. The slope angle is not changed until the number of times of lottery is more than 10. The predetermined number of times of lottery for determining the change of the slope angle is not limited to 10. The number of times which can strike a probable average is set the predetermined number of times of lottery in order to strike an average of the variation of the lottery time of the physical lottery.

### Third Embodiment

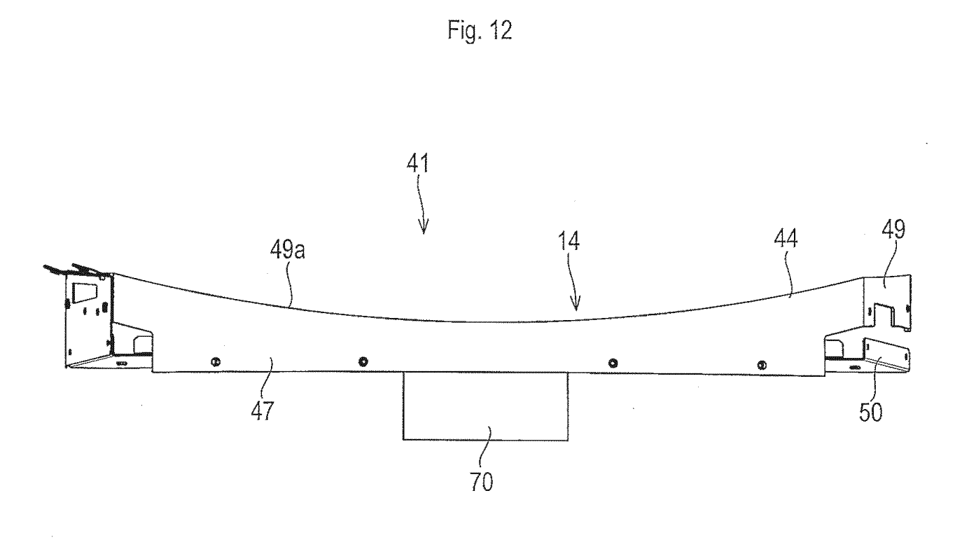

A game machine according to a third embodiment of the present invention will be described with reference to FIGS. 12 to 16. In this embodiment, the same components as those in the above embodiments are denoted by the same reference numeral, and descriptions thereof will be omitted. FIG. 12 is an enlarged view showing the center slope 41 of the game machine 1C according to the third embodiment. In this embodiment, the center slope 41 is fixed to the base portion of the center unit 3, unlike the second embodiment. That is, in this embodiment, the center slope 41 does not swing. In addition, a vibration apparatus 70 as a vibration device is provided on the bottom of the central portion of the center slope 41. The vibration apparatus 70 is provided to vibrate the center slope 41. In the vibration apparatus 70, a well-known vibration motor, for example, in which a weight with an eccentric center of gravity is mounted on the output shaft, is used. The vibration apparatus 70 is not limited to the vibration motor. Any of various devices that can vibrate the center slope 41 may be used as the vibration apparatus 70. Since portions other than these are the same as the second embodiment described above, illustration and description of other portions will be omitted.

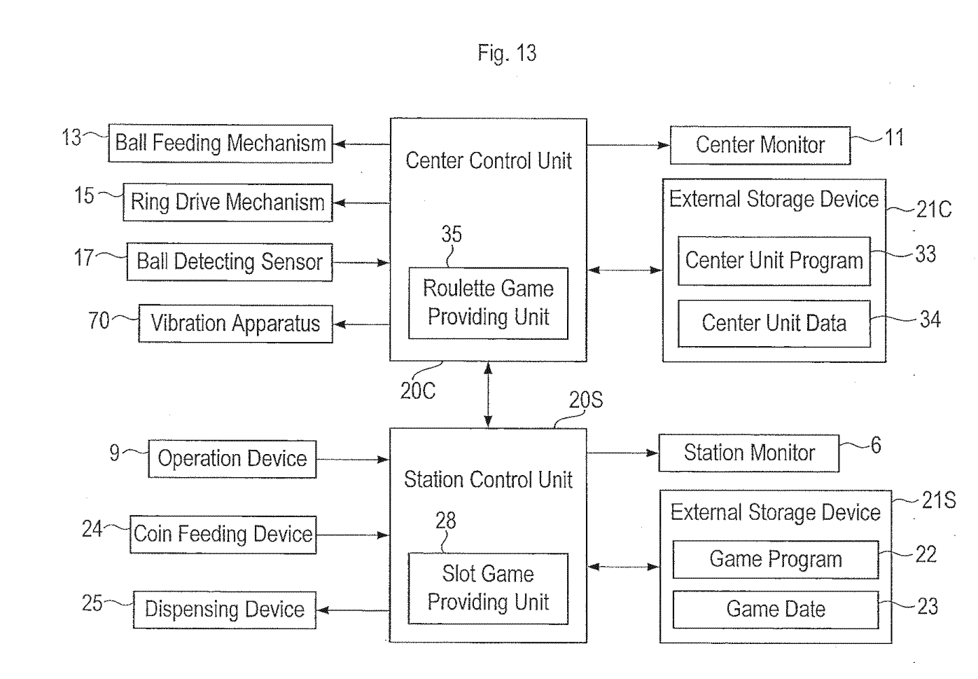

FIG. 13 is a view schematically showing the configuration of the control system of the game machine 1C. As shown in FIG. 13, the vibration apparatus 70 is connected to the center control unit 20C. The center control unit 20C controls the vibration apparatus 70 based on the time elapsed after the ball B is fed. When the center slope 41 is vibrated by the vibration apparatus 70, the speed of the ball B moving on the center slope 41 is lowered by the vibration. Thereby, it becomes easy for the ball B to enter the pocket 16. The center control unit 20C operates the vibration apparatus 70 when the time elapsed after the ball B is fed becomes greater than a predetermined determination time. Thereby, it suppresses the lottery time from being prolonged. As an initial value of the determination time, 30 seconds, for example, is set. The initial value of the determination time is not limited to 30 seconds, and it may set properly so that the lottery time of roulette game is not prolonged excessively.

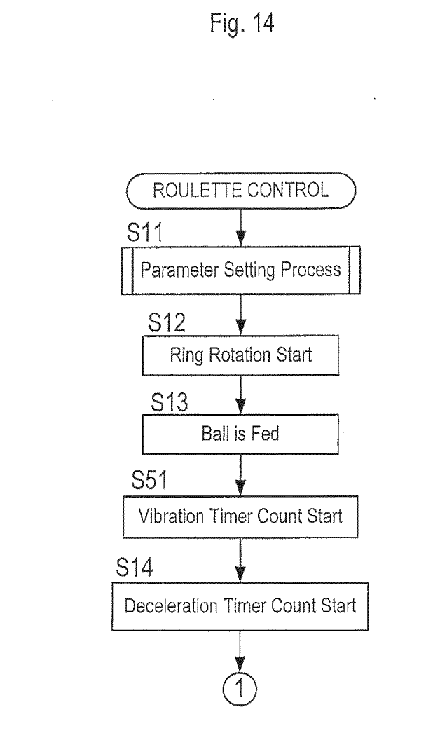

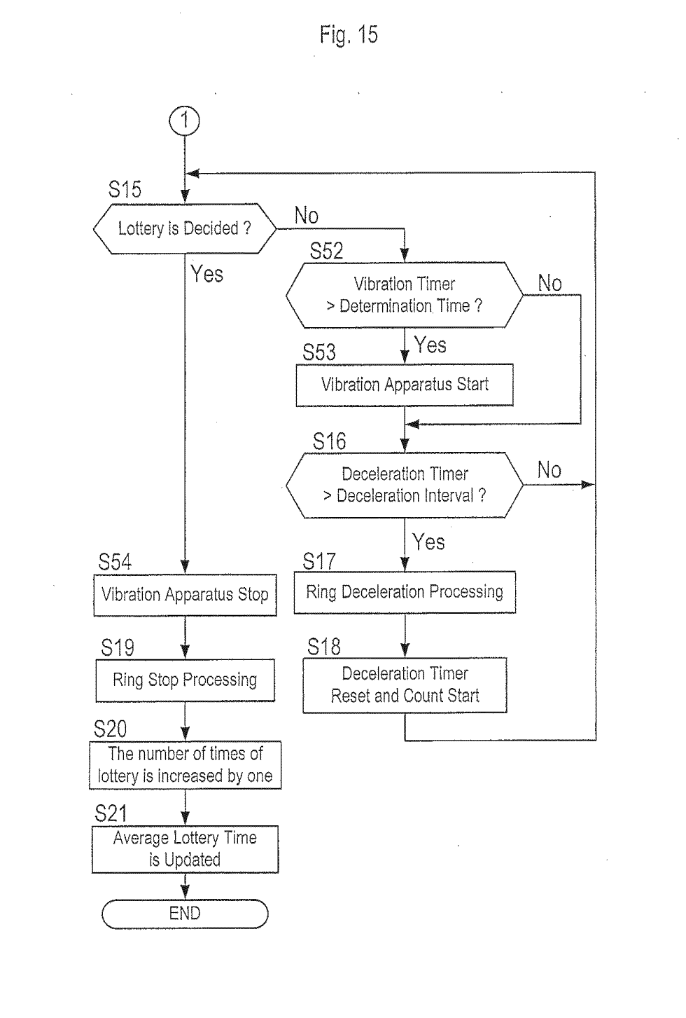

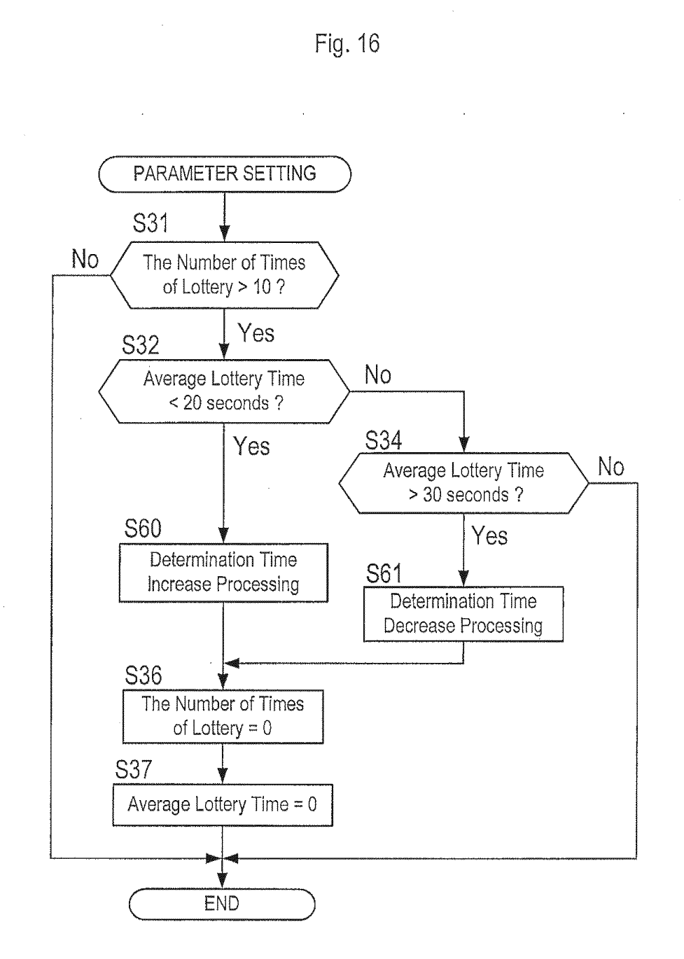

Next, the roulette control routine and parameter setting routine of this embodiment will be described with reference to FIGS. 14 to 16. FIGS. 14 and 15 show the roulette control routine and FIG. 16 shows the parameter setting routine. In these routines, the same processes as those in FIG. 4 or 5 are denoted by the same reference numeral as those in FIG. 4 or 5, and descriptions thereof will be omitted. In the following description, 10 times, 20 seconds, 0.5 seconds and the like are examples of values of the number of times and the times of this embodiment. The number of times and the times are not limited to the above values.

In the control routine of FIG. 14, the center control unit 20C first executes the parameter setting processing at step S11. In the parameter setting processing, the routine of FIG. 16 is executed. In this routine, the center control unit 20C executes the processes until step S32 as with FIG. 5. At step S32, if the center control unit 20C determines that the average lottery time is less than 20 seconds, the center control unit 20C proceeds to step S60 and executes a determination time increase processing. In this processing, a predetermined correction value is added to the determination time. 0.5 seconds is set to the correction value, for example. The correction value is not limited to 0.5 seconds, and any suitable value may be set. Thereafter, the center control unit 20C proceeds to step S36, and executes the processes as with FIG. 5.

On the other hand, if the center control unit 20C determines the average lottery time is 20 seconds or more, the center control unit 20C proceeds to step S34 and determines whether or not the average lottery time is 30 seconds or less. If the center control unit 20C determines that the average lottery time is 30 seconds or less, the center control unit 20C ends the current routine. On the other hand, if the center control unit 20C determines that the average lottery time is greater than 30 seconds, the center control unit 20C proceeds to step S61 and executes a determination time decrease processing. In this processing, the predetermined collection value is subtracted from the determination time. 0.5 seconds is set to the correction value, for example. The correction value is not limited to 0.5 seconds, and any suitable value may be set. Thereafter, the center control unit 20C proceeds to step S36, and executes the processes as with FIG. 5.

Returning to FIG. 14, the description of the roulette control routine will be continued. After executing the parameter setting processing, the center control unit 20C proceeds to step S12 and rotates the roulette ring 12. At step S13, the center control unit 20C feed the ball B. At the next step S51, the center control unit 20C resets the vibration timer to measure the time elapsed after the ball B is fed. Then, it starts the count of the vibration timer. As the vibration timer, a timer which can measure time at an interval of at least 0.1 seconds is used. At the next step S14, the center control unit 20C starts the count of the deceleration timer.

In the next step S15 of FIG. 15, the center control unit 20C determines whether or not the lottery is decided in a roulette game. If the center control unit 20C determines that the lottery is not decided, the center control unit 20C proceeds to step S52 and determines whether or not the value of the vibration timer is greater than the determination time. The determination time is set appropriately so that the lottery time of the roulette game is not prolonged excessively. As the determination time, 30 seconds, for example, is set. If the center control unit determines that the value of vibration timer is less than the determination time, the center control unit 20C skips step S53 and proceeds to step S16. On the other hand, if the center control unit 20C determines that the value of vibration timer is greater than the determination time, the center control unit 20C proceeds to step S53 and starts the vibration apparatus 70. Thereafter, the center control unit 20C proceeds to step S16, and executes the processes as with FIG. 4 until the lottery is decided.

On the other hand, if the center control unit 20C determines that the lottery is decided in the roulette game, the center control unit 20C proceeds to step S54 and stops the vibration apparatus 70. At the next step S19, the center control unit 20C executes the ring stop processing. At the next step S20, the center control unit 20C increases the number of times of lottery by one. At step S21, the center control unit 20C updates the average lottery time based on the lottery time of the game of this round. Thereafter, the center control unit 20C ends the current control routine.

As described above, according to the game machine 1C of the third embodiment, when the time elapsed after the ball B is fed becomes greater than the determination time, the vibration apparatus 70 is operated, so it becomes easy for the ball B to enter the pocket 16. Thereby, it is possible to suppress the lottery time from being prolonged. Since the determination time is changed depending on the average lottery time, it is possible to decrease the variation of the lottery time. Further, since the determination time is changed based on the average lottery time of at least 10 nearest lotteries, it is possible to change the determination time appropriately.

The determination time is not changed until the number of times of the lottery becomes greater than 10. Thereby, it is possible to prevent determination time from being changed needlessly. The determination time is changed before starting the roulette game, and is not changed while the roulette game is being executed.

In this embodiment, when the vibration apparatus 70 is operated, it may be operated in such a way that vibration is generated intermittently. It may also be operated in such a way that vibration is generated continuously.

The center control unit 20C functions as a control device by executing steps S52 and S53 of FIG. 15.

### Fourth Embodiment

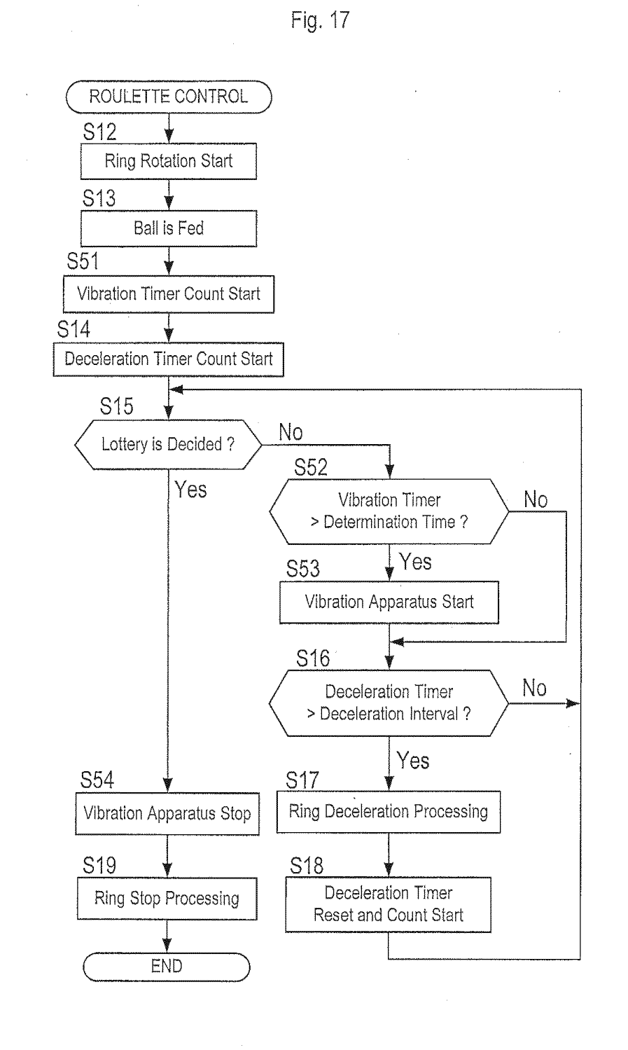

Next, a game machine according to the fourth embodiment of the present invention will be described with reference to FIG. 17. The configuration of the game machine of this embodiment is the same as that of the third embodiment. Thereby, description of the configuration of the game machine will be omitted. FIG. 17 shows a roulette control routine executed by the center control unit 20C in this embodiment. In FIG. 17, the same processes as those in FIG. 4, 14, or 15 are denoted by the same reference numeral as those in FIG. 4, 14, or 15, and descriptions thereof will be omitted. As a determination time used in the control routine in FIG. 17, 30 seconds, for example, is set. The determination time is not limited to 30 seconds, and it may set properly so that the lottery time of the roulette game is not prolonged excessively.

In this control routine, the center control unit 20C first rotates the roulette ring 12 at step S12. Thereafter, the center control unit 20C executes the processes as with FIGS. 14 and 15 until it is determined at step S15 that the lottery is decided in the roulette game. If the center control unit 20C determines that the lottery is decided at step S15, the center control unit 20C proceeds to step S54 and stops the vibration apparatus 70. At the next step S19, the center control unit 20C executes the ring stop processing. Thereafter, the center control unit 20C ends the current control routine.

As described above, according to the fourth embodiment, when the time elapsed after the ball B is fed becomes greater than the determination time, the vibration apparatus 70 is operated, so that it is possible to prevent the lottery time from being prolonged. Thereby, it is possible to decrease the variation of the lottery time.

Also in this embodiment, when the vibration apparatus 70 is operated as in the third embodiment, it may be operated in such a way that vibration is generated intermittently. It may also be operated in such a way that vibration is generated continuously.

The present invention is not limited to the above described embodiments, and may be executed in any appropriate mode. For example, the above described embodiments may be combined appropriately with each other, as long as they do not bother each other. For example, the lottery time may be adjusted by changing both of the deceleration interval and the slope angle of the ball traveling surface. In this case, priority is given to each parameter and the parameter may be changed depending on the priority.

The parameter with the value changed to decrease the variation of the lottery time is not limited to the parameters shown in the above described embodiments. As the parameter for changing the value in the present invention, any of various parameters affecting the lottery time may be used.

In the above embodiments, it is determined whether or not the average lottery time falls within the target range if the number of lotteries is more than 10, but the number of times used in the determination is not limited to 10. Any appropriate number of times may be set so that the parameter value is not changed needlessly. Further, in the above embodiments, the number of times of lottery and the average lottery time are each reset to change the parameter value, but they need not be reset.

In each of the above embodiments, the lottery time is the period from the time when the ball B is fed to the time when the ball B enters any one of the pockets 16, but the lottery time is not limited to this period. For example, the point of time at which the roulette ring 12 starts to rotate may be used as the start of the lottery time. Further, the point of time at which the roulette ring 12 stops completely may be used as the end of the lottery time.

1. A game machine comprising a physical lottery mechanism in which a lottery is executed by a roulette game, wherein the game machine comprises
a parameter changing device configured to change a parameter value which affects lottery time, which is time taken for one lottery of the physical lottery mechanism, of the lottery to be executed by the physical lottery mechanism based on the lottery time of at least one past lottery executed by the physical lottery mechanism, so that the lottery time falls within a predetermined target range.

2. The game machine according to claim 1, wherein
the parameter changing device is configured to change the parameter value before starting the lottery by the physical lottery mechanism and prohibit the change of the parameter value while the lottery is being executed.

3. The game machine according to claim 1, wherein
when the parameter changing device changes the parameter value, the parameter changing device is configured to prohibit the change of the parameter value until the lottery is executed by the physical lottery mechanism predetermined number of times after changing of the parameter value.

4. The game machine according to claim 1, wherein
the physical lottery mechanism includes: a roulette ring having plural pockets which are arranged in a circumference direction over a whole circumference; and a ring drive mechanism which rotates the roulette ring at a predetermined lottery starting speed when the roulette game is started and then decreases a rotation speed of the roulette ring gradually from the lottery starting speed at a predetermined deceleration interval, wherein
the parameter is the deceleration interval.

5. The game machine according to claim 4, wherein
the parameter changing device is configured to change the deceleration interval based on an average lottery time which is an average of the lottery time obtained by the predetermined number of times of nearest lotteries executed by the physical lottery mechanism.

6. The game machine according to claim 5, wherein
the parameter changing device is configured to decrease the deceleration interval when the average lottery time is greater than an upper limit of the target range, and to increase the deceleration interval when the average lottery time is less than a lower limit of the target range.

7. The game machine according to claim 1, wherein
the physical lottery mechanism includes a roulette ring having plural pockets which are arranged in a circumference direction over a whole circumference; a ball guidepath, an upper surface of which the ball travels on, is provided on an outer circumference of the roulette ring; and an angle changing mechanism which changes an angle between an upper surface of the roulette ring and the upper surface of the ball guidepath, wherein
the parameter is the angle between the upper surface of the roulette ring and the upper surface of the ball guidepath.

8. The game machine according to claim 7, wherein
the angle changing mechanism changes the angle between the upper surface of the roulette ring and the upper surface of the ball guidepath over a section in the upper surface of the ball guidepath, the section corresponding to at least three of the pockets.

9. The game machine according to claim 7, wherein
the parameter changing device is configured to change the angle between the upper surface of the roulette ring and the upper surface of the ball guidepath based on an average lottery time which is an average of the lottery time obtained by the predetermined number of times of nearest lotteries executed by the physical lottery mechanism.

10. The game machine according to claim 9, wherein
the parameter changing device is configured to decrease the angle between the upper surface of the roulette ring and the upper surface of the ball guidepath when the average lottery time is greater than an upper limit of the target range, and to increase the angle between the upper surface of the roulette ring and the upper surface of the ball guidepath when the average lottery time is less than a lower limit of the target range.

11. The game machine according to claim 1, wherein
the physical lottery mechanism includes: a roulette ring having plural pockets which are arranged in a circumference direction over a whole circumference; a ball guidepath, an upper surface of which the ball travels on, is provided on an outer circumference of the roulette ring; a vibration device which is able to vibrate the ball guidepath; and a control device which operates the vibration device in a case that time elapsed from when a lottery of the physical lottery mechanism is started is greater than a predetermined determination time, wherein
the parameter is the determination time.

12. The game machine according to claim 11, wherein
the parameter changing device is configured to change the determination time based on an average lottery time which is an average of the lottery time obtained by the predetermined number of times of nearest lotteries executed by the physical lottery mechanism.

13. The game machine according to claim 12, wherein
the parameter changing device is configured to decrease the determination time when the average lottery time is greater than an upper limit of the target range, and to increase the determination time when the average lottery time is less than a lower limit of the target range.

14. A control method of controlling a computer which is incorporated in a game machine comprising a physical lottery mechanism in which a lottery is executed by a roulette game, wherein the control method of controlling the computer comprises
a parameter changing step configured to change a parameter value which affects lottery time, which is time taken for one lottery of the physical lottery mechanism, of the lottery to be executed by the physical lottery mechanism based on the lottery time of at least one past lottery executed by the physical lottery mechanism, so that the lottery time falls within a predetermined target range.

15. A computer program for a game machine being configured to cause a computer, which is incorporated into a game machine comprising a physical lottery mechanism in which a lottery is executed by a roulette game, to function as
a parameter changing device configured to change a parameter value which affects lottery time, which is time taken for one lottery of the physical lottery mechanism, of the lottery to be executed by the physical lottery mechanism based on the lottery time of at least one past lottery executed by the physical lottery mechanism, so that the lottery time falls within a predetermined target range.
